(19) United States
(12) Patent Application Publication
(10) Pub. No.: US 2017/0263988 A1
(43) Pub. Date: Sep. 14, 2017

(54) THERMAL MANAGEMENT IN THE FIELD OF E-MOBILITY

(71) Applicant: CeramTec GmbH, Plochingen (DE)

(72) Inventor: Matthias RASP, Arzberg (DE)

(73) Assignee: CeramTec GmbH, Plochingen (DE)

(21) Appl. No.: 15/529,037

(22) PCT Filed: Nov. 23, 2015
(86) PCT No.: PCT/EP2015/077362

§ 371 Date: May 23, 2017

(30) Foreign Application Priority Data
Nov. 24, 2014 (DE) 10 2014 223 861.7

(51) Int. Cl. H01M 10/6556; H01M 10/6571; H05B 1/00; H01M 10/613; H01M 10/615; F28F 21/04; H01M 10/0525; H01M 10/625

(52) U.S. Cl. CPC H01M 10/6556; H01M 10/0525; H01M 10/6571; H01M 10/625; H01M 10/613; H01M 10/615; F28F 21/04; H05B 1/00; H01M 2220/20

(57) ABSTRACT

The invention relates to a ceramic cooling and heating body for controlling the temperature of components, wherein the cooling and heating body consists of a plate-shaped support with a front side, an opposite rear side and side faces connecting the front side to the rear side, and metallizations, connected to the support, are arranged on the front side and/or the rear side, and the support has cooling elements. In order to be able to control the temperature of any electrical or electronic component, it is proposed according to the invention that a heating structure is affixed to the front side and/or the rear side.

The invention relates to a heating and cooling body for regulating the temperature of components, wherein the heating and cooling body consists of a plate-shaped support element with a front side, an opposite rear side and side faces connecting the front side to the rear side and metallization on the front side and/or rear side connected to the support element, and the support element has cooling elements.

### PRIOR ART

1) Lithium ion batteries (referred to below as Li ion batteries), which are used in electric automobiles, require pre-regulation of temperature when cold in order to be able to achieve an optimum operating state as quickly as possible.

At cold temperatures, the chemical processes (including the decomposition of the battery with aging) proceed more slowly, and the viscosity of the electrolytes used in the lithium cells increases greatly, so there is also an increase in the internal resistance in Li ion batteries at cold temperatures and therefore there is a decline in the power that can be delivered. Furthermore, the electrolytes used may freeze at temperatures around −25° C. Many manufacturers report the operating range as 0 to 40° C. However, the optimum for many cells is 18° C. to 25° C.

Below 10° C., there may be such a great loss of power due to the increased internal resistance with many types of batteries that they are not available for operation for a long period of time. There are special Li ion batteries, which have special electrolytes that can be used down to temperatures of −54° C. Charging them at low temperatures usually results in a very extreme aging which is associated with an irreversible loss of capacitance. For this reason, 0° C. is specified as the lower allowed temperature during the charging operation for most Li ion batteries.

2) Li ion batteries are used in electric automobiles and require cooling to maintain an optimum operating state and prevent the cells from overheating. A longer lifetime of the battery cells can also be achieved by means of cooling.

If the operating temperatures are too high, a layer is formed on the anode of many systems due to decomposition of the electrolyte, which then greatly increases the internal resistance of the cell. The temperature during the discharging operation is therefore limited to 60° C. by most manufacturers.

In various lithium ion batteries, under thermal load, the separator may melt and thus cause an internal short circuit with an abrupt release of energy (heating, catching fire). Another source of danger is from exothermic decomposition reactions of the cell chemicals in an overload, in particular during charging.

3) All electronic power systems in electric vehicles have the same fundamental functions—transferring electric power from a source for conversion into mechanical power or for storing in a battery. A battery stores electricity as a d.c. voltage. The engine uses electric power in the form of an alternating voltage. The voltage is turned off and on very rapidly by switches, for example, IGBT or MOSFET (power transistors). Since the transistors conduct more current from the battery to the motor, the alternating voltage shows an increase in amplitude until the maximum torque is generated in the engine. Much of the heat that must be dissipated is generated in this process due to the power loss by the power transistors. Heat sinks such as air-cooled or liquid-cooled systems made of aluminum or copper may be used here. With the increase in efficiency of computer chips and thus also an increase in power density, optimum heating becomes progressively more difficult.

The invention is based on the object of improving upon a ceramic heating and cooling body according to the preamble of claim 1, so that it can be used for thermal regulation of any electric or electronic components. In particular, the heating and cooling body should be used for heating and/or cooling of batteries and for cooling electronic power devices in electric vehicles.

According to the invention, this object is achieved by the fact that a heating structure is applied to the front side and/or rear side. The ceramic heating and cooling body according to the invention can be both cooled and heated in this way.

In a preferred specific embodiment, the heating structure has two terminal poles, and both of the terminal poles are continued as far as the edge of the front side and/or rear side, on which the heating structure is situated, and they are guided from there around the edge between the front side and the side face, each opening into a metallized connection point on the side face. The terminal poles for the heating structure are therefore arranged at a distance from the heating structure, so that they have no room on the bottom side, where the heating structure is located. Furthermore, connection to a voltage source is great facilitated.

The heating structure preferably covers the entire front side and/or rear side in a meandering arrangement. The amount of surface area heated is maximized in this way.

In an advantageous specific embodiment of the invention, the cooling elements are cooling channels having at least one inlet opening and at least one outlet opening in the support body, or they are external cooling ribs, which are designed in one piece with the support body. The heating and cooling bodies may this be liquid-cooled or air-cooled or both, depending on the field of application.

In liquid cooling, the cooling channels are arranged in parallel side by side in a preferred specific embodiment, wherein all the inlet openings are preferably arranged on one side face of the heating and cooling body and all the outlet openings are arranged on the opposite side face of the heating and cooling body. In this way the heating and cooling bodies can be produced by extrusion molding.

In a preferred specific embodiment, the metallization is sintered to the support body. On the one hand, the metallization is anchored to the support body extremely securely in this way, as well as being optimally thermally connected to the support body. It has been found in many experiments that separation of the metallization from the support body can be prevented only by sintered metallization. Furthermore, there is no heat buildup because the heat that is generated is diverted immediately by way of the sintered metallization into the support body.

In preferred specific embodiments, the components are electrical or electronic power components, whose terminal poles are connected to the metallization. These components generate extreme heat, which is dissipated rapidly and absolutely safely by the heating and cooling bodies.

In one application case, several heating and cooling elements with cooling channels on the inside are arranged parallel to one another and the inlet openings and outlet openings of the heating and cooling bodies are connected to central inlet and outlet lines for the cooling medium. This creates an array of multiple heating and cooling bodies, so that several components can be cooled at the same time.

It is advantageous here if the components are arranged between the cooling and heating bodies and are connected to them in a manner such that they conduct heat. A type of sandwich architecture is created. The thermal coupling is optimized while the space demand is minimized at the same time.

The components are preferably batteries, in particular lithium ion batteries, which can be used sensibly only in a certain temperature range.

The use of a heating and cooling body according to the invention is preferred for electric drive vehicles.

The heating and cooling body according to the invention is made of a ceramic and/or a plate-shaped ceramic support body, which is air-cooled or liquid-cooled and serves as a support for electric or electronic components, wherein the ceramic is provided with metallization at the required locations and the components are electrically connected to these metallized locations. In a preferred specific embodiment, the metallized locations are sintered to the ceramic. For air cooling, the ceramic may be made of a plate-shaped support, which is provided with cooling ribs in one piece on one side and has the metallized locations on the other side. For liquid cooling, the ceramic may contain channels through which a cooling liquid is pumped.

In one embodiment according to the invention, the battery cells of the lithium ion batteries are brought to temperature with the help of the ceramic heating and cooling bodies according to the invention, which have metallized heating structures.

In another embodiment according to the invention, power modules are applied to the heating and cooling bodies with the help of a metallic connection (having a good thermal conductivity) by soldering/bonding.

The ceramics may be simple substrates, they may have a three-dimensional structure (for example fins, and/or cooling ribs) or they may have closed channels or chambers (with connecting openings facing outward). The cooling itself may be accomplished by means of a gas or a liquid.

Metallized areas may be filled and hardened paints, which may include the usual thick-film metallized areas, such as those made of tungsten, molybdenum, silver, silver-palladium, silver-platinum, etc., but also AMB or DCB.

The cooling bodies may be produced from the usual ceramics, such as Al₂O₃, MgO, SiO₂, mixed oxide ceramics or nitride ceramics such as AlN, Si₃N₄. They may be converted to the desired shape by means of film casting, extrusion molding, dry pressing, injection molding, hot molding, high pressure die casting or by mechanical processing of blankets of ceramic materials or unsintered molded bodies (green bodies) that are subsequently sintered.

### EXAMPLE

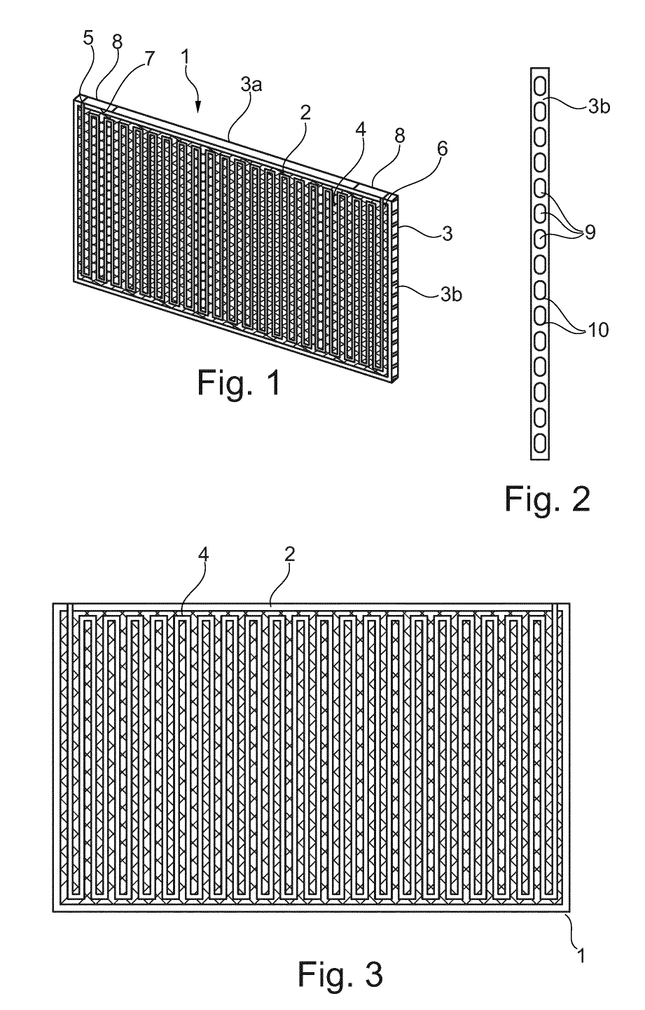

FIGS. 1, 2 and 3 show several views of a plate-shaped heating and cooling body 1 made of a ceramic. FIG. 1 shows the front side 2 and two side faces 3a, 3b of the heating and cooling body 1. FIG. 2 shows a view of the side face 3b, and FIG. 3 shows the front side 2 of the heating and cooling body 1.

The heating and cooling body 1 consists of a front side 2 and a rear side (not shown), wherein the front side 2 is connected to the rear side by means of side faces 3. The heating and cooling body 1 is provided with a heating structure 4 on its front side 2. In the specific embodiment shown here, the heating structure 4, which is designed in a meandering shape, covers the entire front side 2. Both terminal poles 5, 6 of the heating structure 4 are continued to the edge of the front side 2 of the heating and cooling body 1 and are guided around the edge 7, each opening into a metallized connecting site 8 on the side face 3a.

For cooling the heating and cooling body 1, it has internal cooling channels 9 through which a cooling liquid is pumped. In the specific embodiment shown here, these cooling channels 9 are arranged parallel to one another, wherein all the inlet openings 10 are arranged on the side face 3b and all the outlet openings are arranged on the opposite side face of the heating and cooling body 1.

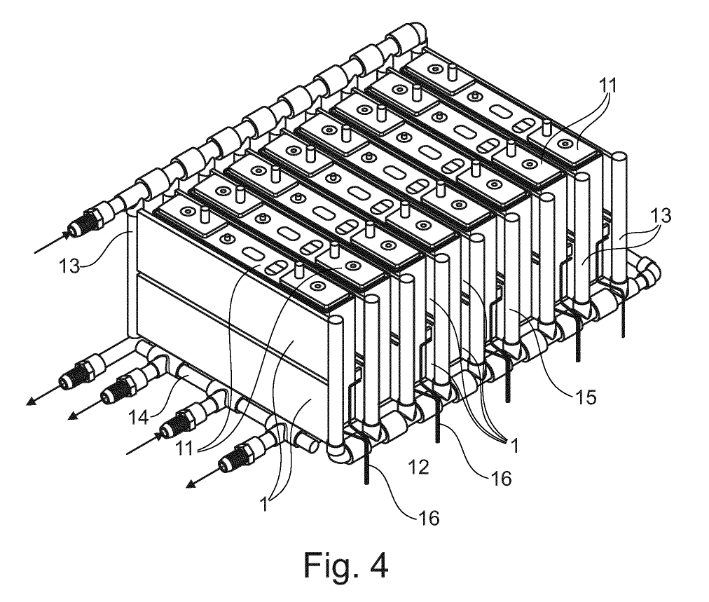

This heating and cooling body 1 is connected to the battery cells 11 (see FIG. 4) of the lithium ion battery in such a way that good dissipation of heat and good input of heat are ensured so a good thermal contact is established.

The heating and cooling body 1 shown here may have metallization on the rear side opposite the heating structure 4 and components to be cooled may be soldered there.

The cooling by means of the cooling channels 9 can be replaced or enhanced by fins on the rear side of the heating and cooling body. In this case the fins would be cooled by a gas, for example, air.

FIG. 4 shows battery cells 11 of a lithium ion battery arranged between two heating and cooling bodies 1. These heating and cooling bodies 1 are identical to those of FIGS. 1 to 3. The battery cells 11 may be connected to the heating and cooling bodies 1 with a good heat conducting paste. In order to be able to pump cooling fluid through the internal cooling channels 9 (see FIGS. 1 to 3) of the heating and cooling body 1, the internal cooling channels 9 are connected to external cooling lines 13. There is a bottom cooling channel 14 and two side cooling channels 15, each having an inlet and at least one outlet. The heating structures 4 on the heating and cooling bodies 1 are connected to at least one electric power source (not shown) by means of electric connecting lines 16.

1. A ceramic heating and cooling body for regulating the temperature of components, wherein the heating and cooling body comprises a plate-shaped support with a front side, a rear side opposite that and side faces connecting the front side to the rear side, and metallized areas connected to the support are arranged on the front side and/or the rear side, and the support has cooling elements, characterized in that a heating structure is applied to the front side and/or the rear side.

2. The heating and cooling body according to claim 1, wherein the heating structure has two terminal poles and both terminal poles are continued to the edge of the front side and/or the rear side, where the heating structure is located, and continue from there around the edge between the front side and the side face and a metallized terminal point on the side face opens into each.

3. The heating and cooling body according to claim 1, wherein the heating structure covers the entire front side and/or rear side in a meandering pattern.

4. The heating and cooling body according to claim 1, wherein the cooling elements are internal cooling channels having at least one inlet opening and at least one outlet opening in the support, or they are external cooling ribs, which are designed in one piece with the support.

5. The heating and cooling body according to claim 4, wherein the cooling channels are arranged parallel to one another, wherein all the inlet openings are arranged on one side face and all the outlet openings are arranged on the opposite side face of the heating and cooling body.

6. The heating and cooling body according to claim 1, wherein the metallized areas are sintered to the support.

7. The heating and cooling body according to claim 1, wherein the components are electric or electronic power components, whose terminal poles are connected to the metallized areas.

8. The heating and cooling body according to claim 1, wherein several heating and cooling bodies having internal cooling channels are arranged parallel to one another, and the inlet openings and the outlet openings of the heating and cooling bodies are connected to central inlet and outlet lines for the cooling medium.

9. The heating and cooling body according to claim 8, wherein the components are arranged between the heating and cooling bodies and are connected to them in a heat conducting manner.

10. The heating and cooling body according to claim 1, wherein the components are batteries, in particular lithium ion batteries.

11. A use of a heating and cooling body according to claim 1 in vehicles having electric drive.
